(19) United States
(12) Patent Application Publication
(10) Pub. No.: US 2015/0092051 A1
(43) Pub. Date: Apr. 2, 2015

(54) MOVING OBJECT DETECTOR

(71) Applicant: Toshiba Alpine Automotive Technology Corporation, Iwaki-shi (JP)

(72) Inventor: Kenji FURUKAWA, Fukushima-ken (JP)

(73) Assignee: Toshiba Alpine Automotive Technology Corporation, Iwaki-shi (JP)

(21) Appl. No.: 14/176,453

(22) Filed: Feb. 10, 2014

(30) Foreign Application Priority Data
Oct. 2, 2013 (JP) 2013-207572

(51) Int. Cl. G06T 7/20; H04N 7/18; G06T 7/00; H04N 5/232

(52) U.S. Cl. CPC G06T 7/20; H04N 5/23229; H04N 7/183; G06T 7/004; G06T 2207/30232; G06T 2207/10004
USPC 348/143

(57) ABSTRACT

According to one embodiment, a moving object detector includes an image input device and an image processing device. The image input device captures a moving object existing at a close distance to acquire image information of the moving object. The image processing device applies arithmetic processing to the image information to generate a cylindrical binary image and a top view binary image, extracts a region of the moving object by background correlation, estimates an approaching direction of the moving object from the cylindrical binary image, and estimates a motion trajectory of the moving object based on the approaching direction and the top view binary image.

### CROSS-REFERENCE TO RELATED APPLICATIONS

This application is based upon and claims the benefit of priority from the prior Japanese Patent Application No. 2013-207572 filed on Oct. 2, 2013, the entire contents of which are incorporated herein by reference.

### FIELD

An embodiment described herein relate generally to a moving object detector that accurately estimates a motion trajectory of a moving object existing at a close distance therefrom.

### BACKGROUND

Various human monitoring systems realized using a camera, such as a monitoring system for security purpose, an on-vehicle monitoring system for safety purpose, and a monitoring system for vending machine, have been proposed.

In order for such a system to perform various processing in accordance with to motion of an object to be monitored, accurate estimation of a motion trajectory is essential.

The monitoring system for security purpose is often used in a scene where a sufficient distance is provided between an object to be monitored and a camera. In such a case, an angle of view is narrow, and an image having a little distortion can be used, allowing accurate estimation of the motion trajectory.

On the other hand, the on-vehicle monitoring system for safety purpose or monitoring system for vending machine is used in a scene where an object to be monitored is positioned at a close distance from the camera, a fish-eye lens is required to cover an angle of view. The use of the fish-eye lens increases distortion such as projection plane displacement, making it difficult to achieve accurate estimation of the motion trajectory.

### BRIEF DESCRIPTION OF THE DRAWINGS

FIG. 1 is a view illustrating an example of a moving object detector according to an embodiment of the present invention;

FIG. 2 is a view illustrating an example of an image processing device;

FIG. 3A is a view for explaining generation of an top view image, and FIG. 3B is a view for explaining generation of a cylindrical image;

FIG. 4 is a flowchart illustrating a flow of generation processing of a background difference;

FIG. 5 is a flowchart illustrating a flow of estimation processing of an approaching direction;

FIG. 6 is a flowchart illustrating a flow of estimation processing of a motion trajectory;

FIGS. 7A and 7B are graphs each explaining two-stage binarization processing; and

FIGS. 8A to 8M are views each illustrating an example of a processed image.

### DETAILED DESCRIPTION

According to one embodiment, a moving object detector includes an image input device that captures a moving object existing at a close distance to acquire image information of the moving object; and an image processing device that applies arithmetic processing to the image information to generate a cylindrical binary image and a top view binary image, extracts a region of the moving object by background correlation, estimates an approaching direction of the moving object from the cylindrical binary image, and estimates a motion trajectory of the moving object based on the approaching direction and the top view binary image.

An embodiment of the present invention will be described with reference to the drawings. Throughout the drawings, the same reference numerals are used to designate the same or similar components, and redundant descriptions thereof are omitted.

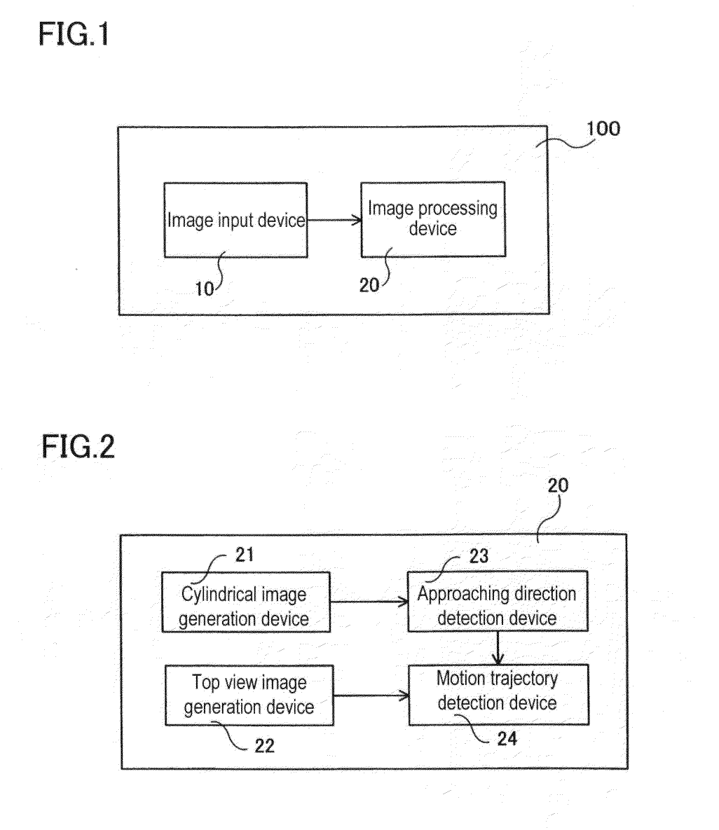

FIG. 1 is a view illustrating a configuration example of a moving object detector according to the embodiment of the present invention. As illustrated in FIG. 1, a moving object detector 100 mainly includes an image input device 10 and an image processing device 20. The image input device 10 captures an image of a person to be detected existing at a close distance therefrom and is preferably a wide-angle camera and, more preferably, a fish-eye camera which is a super wide-angle camera.

The image processing device 20 applies arithmetic processing to image information acquired by the image input device 10 to thereby estimate a motion trajectory of the person. The image processing device 20 can be realized by, e.g., a CPU.

FIG. 2 is a view illustrating a configuration example of the image processing device 20. As illustrated in FIG. 2, the image processing device 20 can be mainly constituted by a cylindrical image generation device 21, an top view image generation device 22, an approaching direction detection device 23, and a motion trajectory detection device 24. The cylindrical image generation device 21 generates a cylindrical binary image from the image information acquired by the image input device 10. Details of the generation of the cylindrical binary image will be described later. The top view image generation device 22 generates a top view binary image from the image information acquired by the image input device 10. Details of the generation of the top view binary image will be described later. The approaching direction detection device 23 detects an approaching direction from the cylindrical binary image. The motion trajectory detection device 24 estimates a motion trajectory from the approaching direction and top view binary image.

Details of the moving object detector 100 having the above configuration will be described.

In the present embodiment, estimation of the motion trajectory is performed as follows: an input image is converted into the cylindrical image and top view; a region of a moving object existing at a close distance is extracted from image plane of both the cylindrical and top view images by background correlation; the approaching direction of the moving object is estimated from the cylindrical binary image; and the motion trajectory is estimated from the approaching direction and top view binary image.

### <Generation of Cylindrical Image>

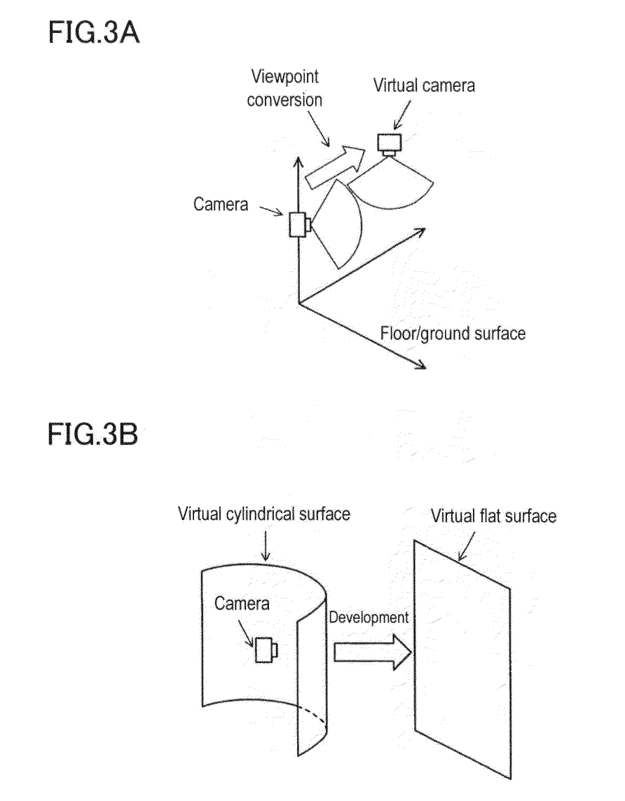

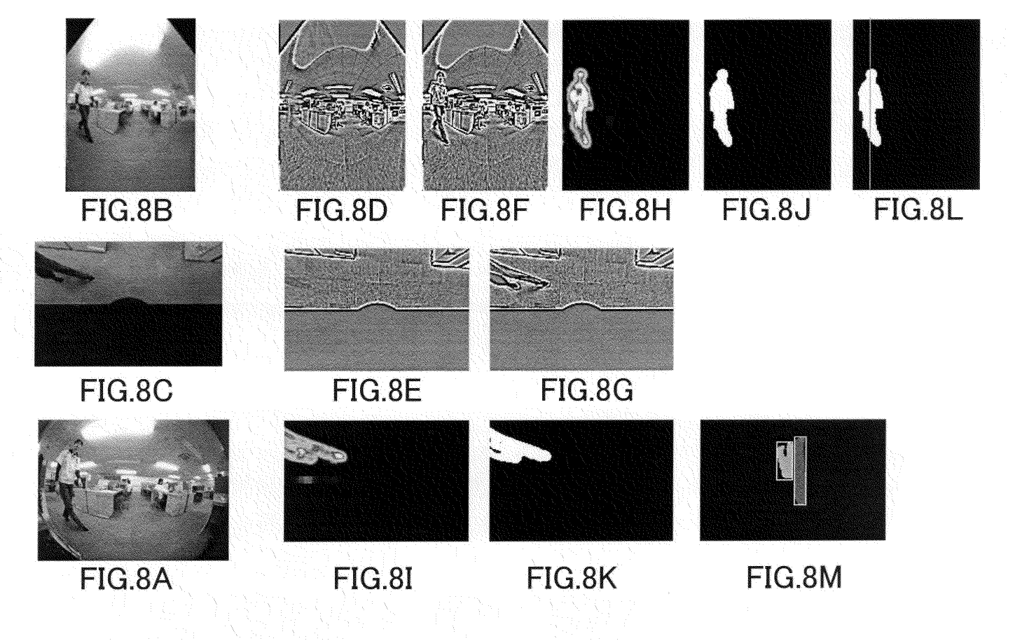

The cylindrical image is an image obtained by developing, on a virtual flat surface, the image information obtained by capturing an object existing on a virtual cylindrical surface with the image input section 10 (e.g., fish-eye camera). FIG. 3B is a view for explaining the generation of the cylindrical image. The generation of the cylindrical image is described in detail in, e.g., Japanese Patent Application Laid-Open Publication No. 2010-217984 and is thus not described in detail herein. FIG. 8B illustrates an example of the cylindrical image which is generated from an input image of FIG. 8A by coordinate conversion. A size of the cylindrical image to be generated needs to be determined depending on a field angle of a camera to be used, a resolution of a sensor to be used, and the like. In the present embodiment, the size of the cylindrical image is assumed to be 128×168.

### <Generation of Top View Image>

In the present embodiment, an image obtained by capturing, with a virtual camera disposed at a given spatial position, an image of a region right therebelow is used as the top view image. Specifically, the image information obtained by image capturing with the image input section 10 (e.g., fish-eye camera) is subjected to viewpoint conversion (top view conversion). FIG. 3A is a view for explaining the generation of the top view image. The generation of the top view image is described in detail in, e.g., Japanese Patent Application Laid-Open Publication No. 2012-141972 and is thus not described in detail herein. FIG. 8C illustrates an example of the top view image which is generated from an input image of FIG. 8A by coordinate conversion. A size of the top view image to be generated needs to be determined depending on a field angle of a camera to be used, a resolution of a sensor to be used, and the like. In the present embodiment, the size of the cylindrical image is assumed to be 180×120.

### <Extraction of Moving Object Region>

In the present embodiment, the following processing are performed for the cylindrical image and top view image independently of one another to generate the cylindrical binary image and top view binary image: (1) generation of a peripheral difference image (edge image); (2) generation of a background correlation image from a current frame and a background image; and (3) extraction of only the moving object using a two-stage Otsu's binarization method.

A background difference refers to an operation of comparing an acquired observation image and a previously acquired background image and subtracting the background image from the observation image to cut out a foreground image, that is, an operation of extracting an object that does not exist in the background image. A region occupied by the object that does not exist in the background image is referred to as a foreground region, and a remaining region is referred to as a background region. FIG. 8D is an example of a cylindrical background image, and FIG. 8E is an example of a top view background image.

In the present embodiment, a person existing at a close distance with respect to a still background image is grasped as a moving object.

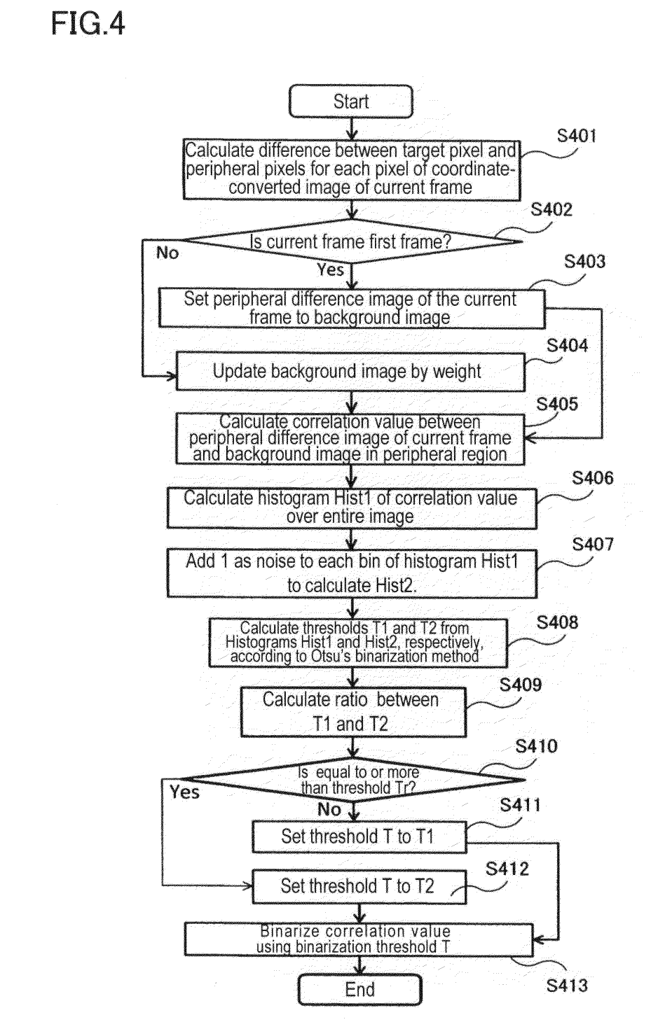

FIG. 4 is a flowchart illustrating a flow of generation processing of the background difference.

First, a difference between a target pixel and its peripheral pixels is calculated for each pixel of coordinate-converted image of current frame according to the following expression (step S401).

$${I}_{differ} ( x , y ) = I ( x , y ) - \frac{1}{N} \sum I ( x , y ) \qquad ( 1 )$$

where Idiffer(x,y) denotes the difference value from peripheral region, I(x,y) denotes the target pixel, N is a size of peripheral region and has preferably size of about 9×9 pixels.

FIG. 8F is an example of the cylindrical image of the current frame which is generated from the coordinate-converted image of FIG. 8B. FIG. 8G is an example of the top view image of the current frame which is generated from the coordinate-converted image of FIG. 8C. As is clear from FIGS. 8F and 8G, the difference from the peripheral region is obtained by enhancing only a texture component of a scene and, thus, it is possible to suppress false detection due to a variation (offset component) in the entire luminance occurring in association with camera's automatic exposure control or degradation of positional accuracy due to shadow of a foot region to be detected. The coordinate-converted image is obtained by coordinate-converting the image information over the entire pixels acquired by the image input section 10 according to a previously prepared predetermined conversion table.

Next, it is determined whether or not the current frame is a first frame (step S402).

When it is determined that the current frame is a first frame (Yes in step S402), the peripheral difference image of the current frame is set to the background image (step S403), and the flow shifts to step S405.

On the other hand, when it is determined that the current frame is not the first frame (No in step S402), the background image Iback(x,y) is updated by a weight a as represented in the following expression (2) (step S404).

I_{back}(x,y)=α·I_{back}′(x,y)+(1−α)·I_{differ}(x,y) (2)

where I′back(x,y) denotes a background image of a previous frame.

The background image is dynamically learned by the above processing. Here, the smaller a value of a is, the greater influence of the current frame image becomes to enhance resistance to noise occurring between frames, whereas sensitivity to the moving object as the foreground image becomes worse (difference becomes small). On the other hand, the larger the value of α is, the easier the difference is to perceive, whereas the more likely information of a person who has passed in front of the camera remains, which may cause false detection. Preferably, the value of α is set to 0.5 to 0.03.

Then, a correlation value Icorr(x,y) (SSD: Sum of Squared Difference) between the peripheral difference image of current frame and background image in a peripheral region S is calculated according to the following expression (3) (step S405).

$${I}_{corr} ( x , y ) = \frac{1}{S} \sum {\vert {I}_{differ} ( x , y ) - {I}_{back} ( x , y ) \vert}^{2} \qquad ( 3 )$$

Spike noise is suppressed by the above processing. Here, S is a rectangular region around a target pixel and has preferably a size of about 7×7 pixels. FIG. 8H is an example of a cylindrical correlation image. FIG. 8I is an example of a top view-correlation image. In FIGS. 8H and 8I, a brighter region has a larger difference from the background image.

Subsequently, a histogram Hist1 of the correlation values is calculated over the entire image (step S406). When no person exists, application of the Otsu's binarization method to this histogram may set an unreasonably low threshold for extracting background noise.

Then, 1 is added as noise to each bin of the histogram Hist1 to calculate a histogram Hist2 (step S407). The value to be added is not limited to “1”, and a larger value than 1 may be effective depending on a form of the background noise. This processing allows improvement of the threshold that has been set to an unreasonably low value due to absence of the person on the image.

Subsequently, thresholds T1 and T2 are calculated from the Histograms Hist1 and Hist2, respectively, according to the Otsu's binarization method (step S408). As a method of automatically calculating a threshold for binarization of a gray scale image, there is known a method based on a discriminant analysis method, called Otsu's binarization method. The Otsu's binarization method assumes that a histogram of a gray scale image has two peaks corresponding respectively to a target object (person, in the present embodiment) and a background (noise component in the correlation image) and calculates a threshold at which a separability between two classes of the target object and background in the image becomes highest. an intra-class variance and an inter-class variance are calculated for each value as a threshold, and a value at which a ratio between the intra-class variance and the inter-class variance becomes minimum is set as a threshold.

Then, a ratio R (=T2/T1) between T1 and T2 is calculated (step S409).

Subsequently, it is determined whether or not the ratio R is equal to or more than a threshold Tr (step S410).

When it is determined that the ratio R is not equal to or more than the threshold Tr (No in step S410), a binarization threshold T is set to T1 (step S411). When it is determined that the ratio R is equal to or more than the threshold Tr (Yes in step S410), a binarization threshold T is set to T2 (step S412). Although the Otsu's binarization method is not suitable for an image having no clear bimodal distribution, the above processing reduces adverse effect caused by the Otsu's binarization method, that is, it is possible to prevent a low threshold from being automatically generated.

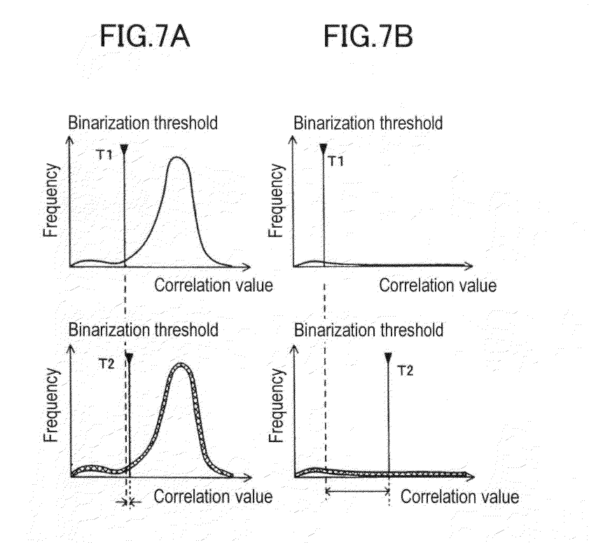

FIGS. 7A and 7B are views each explaining the two-stage Otsu's binarization method. FIG. 7A illustrates a case where T1 is used as the binarization threshold. As illustrated in FIG. 7A, even in a case where a noise component is added, similar binarization effect can be obtained irrespective of whether T1 or T2 is used. FIG. 7B illustrates a case where T2 is used as the binarization threshold. It can be determined from FIG. 7B that T1 reacts to the noise. That is, the binarization effect significantly differs between T1 and T2.

Then, the correlation value is binarized using the binarization threshold T (step S413), and the background difference generation processing is ended. FIG. 8J is an example of a cylindrical binary image. FIG. 8K is an example of a top view binary image.

### <Estimation of Approaching Direction>

In the present embodiment, the following processing are performed to estimate the approaching direction of the moving object from the cylindrical binary image: (1) projection of the cylindrical binary image in a y-direction to calculate center of gravity of a moving object (2) calculation of an approaching direction of a person from the center of gravity coordinates.

FIG. 5 is a flowchart illustrating a flow of estimation processing of the approaching direction.

First, the cylindrical binary image is input (step S501).

Then, a histogram P(x) of the binary image is calculated for each x-coordinate of the image (step S502).

Then, a maximum coordinate xmax of a histogram P(x) is calculated, and a maximum value Pmax thereof is stored (step S503).

Then, it is determined whether or not the maximum value Pmax of the histogram is equal to or more than a threshold (step S504). That is, it is determined in this processing that there is no moving object when a ratio of the maximum histogram projected in the y-direction relative to a height of the image is equal to or less than a predetermined value, whereby false detection is suppressed. The threshold is preferably set to a value obtained by multiplying the image height by a predetermined coefficient (e.g., 0.2).

When it is determined that the maximum value Pmax of the histogram is equal to or more than the threshold (Yes in step S504), a barycenter X_{gravity} is calculated according to the following expression (4) near the maximum coordinate xmax (step S505). FIG. 8L is an example of an image representing the center of gravity position with a white vertical line.

x_{gravity}=Σ(x·P(x))/ΣP(x) (4)

Then, the barycenter X_{gravity} and a conversion coefficient A[deg/pix] are multiplied to calculate an approaching direction θ of the moving object (person) (step S506), and the estimation processing of the approaching direction is ended. The conversion coefficient A is calculated based on a relationship between a horizontal angle of view [deg] of a camera to be used and a width [pix] of the generated cylindrical image.

On the other hand, when it is determined that the maximum value Pmax of the histogram is not equal to or more than the threshold (No in step S504), it is determined that there is no moving object (person) (step S507), and the estimation processing of the approaching direction is ended.

### <Detection of Motion Trajectory>

In the present embodiment, the following processing are performed to estimate the motion trajectory from the approaching direction and top view binary image: (1) rotation of the top view binary image using the approaching direction calculated on the cylindrical image and correction of the rotation of the top view binary image such that the moving object always faces the front; (2) labeling of the rotation-corrected top view binary image to calculate a foot candidate region; (3) estimation of a distance from a foot region by a weighted mean of an area of the foot candidate region; and (4) calculation of a foot position for each frame based on the approaching direction and distance from the foot region.

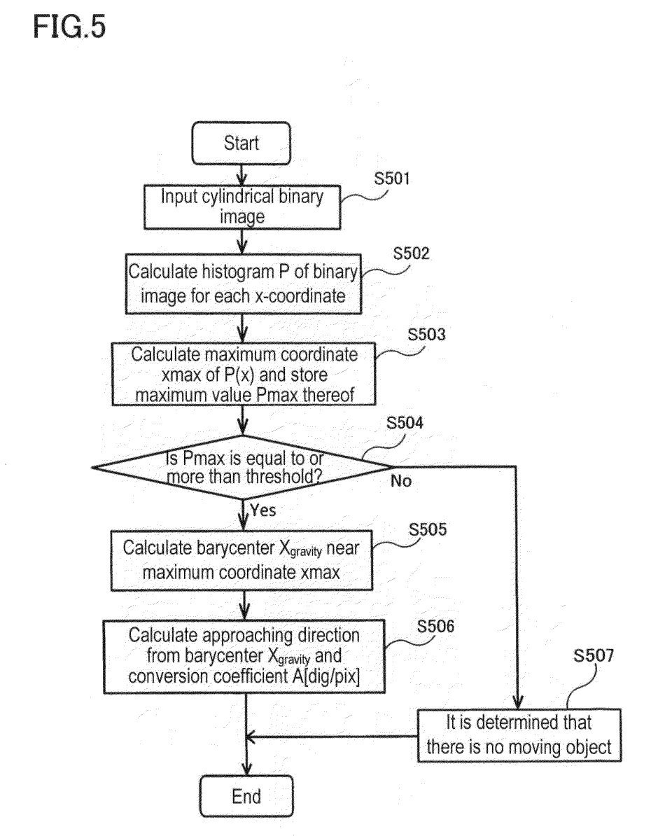

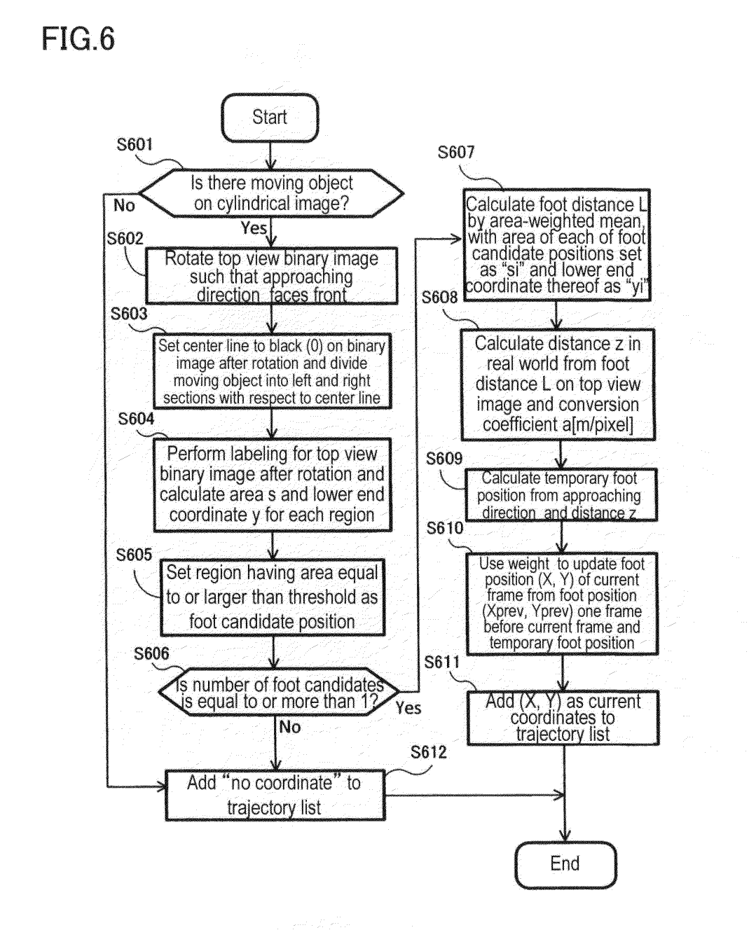

FIG. 6 is a flowchart illustrating a flow of estimation processing of the motion trajectory.

First, it is determined whether or not the moving object exists on the cylindrical image (step S601).

When it is determined that the moving object exists on the cylindrical image (Yes in step S601), the top view binary image is rotated such that the approaching direction θ faces the front (step S602). This allows the moving object (person) to face an observer.

Then, a center line is set to black (0) on the binary image after rotation, and the moving object is divided into left and right sections with respect to the center line (step S603).

Then, labeling is performed for the top view binary image after rotation, and an area sand a lower end coordinate y for each region are calculated (step S604). The labeling is processing of assigning the same number (label) to successive white (or black) pixels in an image that has been subjected to binarization and classifying a plurality of regions into a group. Here, the foot candidate region is calculated by acquiring area information of each region. FIG. 8M is an example of an image after rotation and labeling.

Then, a region having an area equal to or more than a threshold is set as a foot candidate position (step S605). This processing is for removing noise and determining a case where the moving object (person) does not exist around the foot of the camera installation location. The threshold to be used here is set depending on a size of the noise to be removed and is preferably about 50.

Then, it is determined whether or not the number of the foot candidates is equal to or more than 1 (step S606).

When it is determined that the number of the foot candidates is equal to or more than 1 (Yes in step S606), a foot distance L on the top view image is calculated by an area-weighted mean, with an area of each of the ith foot candidate positions set as “si” and a lower end coordinate thereof as “yi” (step S607). The foot distance L can be calculated according to the following expression (5).

L=Σ(sᵢ·yᵢ)/Σsᵢ (5)

Then, a distance z in the real world is calculated from the foot distance L on the top view image and a conversion coefficient a[m/pixel] (step S608). The distance z can be calculated according to the following expression (6).

z=a×L (6)

As the conversion coefficient a, a metric size of one pixel of the generated top view image in areal plane is previously calculated.

Subsequently, a temporary foot position (Xtemp, Ytemp) is calculated from the approaching direction θ and distance z according to the following expression (7) (step S609).

xₜₑₘₚ=z·cos θ, yₜₑₘₚ=z·sin θ (7)

Then, a weight β is used to update a foot position (X, Y) of the current frame from a foot position (Xprev, Yprev) one frame before the current frame and temporary foot position (Xtemp, Ytemp) according to the following expressions (8) and (9) (step S610). The weight β is a coefficient defined by considering accuracy of the foot position calculated in the current frame. When a value of β is reduced, resistance to the noise increases, whereas a time delay occurs. When a value of β is increased, sensitively to the noise increases, whereas the latest information can be obtained. The value of β is preferably about 0.3.

X=β·Xₜₑₘₚ+(1−β)·Xₚᵣₑᵥ (8)

Y=β·Yₜₑₘₚ+(1−β)·Yₚᵣₑᵥ (9)

Then, obtained (X, Y) is added as current coordinates to a trajectory list (step S611), and the estimation processing of the motion trajectory is ended.

On the other hand, when “No” (moving object does not exist on the cylindrical image) is determined in step S601 and when “No” (there is no foot candidate) is determined in step S606, information indicating “no coordinate” is added to the trajectory list (step S612), and the estimation processing of the motion trajectory is ended.

According to the present embodiment, it is possible to accurately estimate the motion trajectory of a moving object (e.g., person) existing at a close distance.

Although the embodiment of the invention has been described above, it is just an example and should not be construed as restricting the scope of the invention. This novel embodiment may be practiced in various other forms, and part of it may be omitted, replaced by other elements, or changed in various manners without departing from the spirit and scope of the invention. These modifications are also included in the invention as claimed and its equivalents.

What is claimed is:

1. A moving object detector comprising:
an image input device that captures a moving object existing at a close distance to acquire image information of the moving object; and
an image processing device that applies arithmetic processing to the image information to generate a cylindrical binary image and a top view binary image, extracts a region of the moving object by background correlation, estimates an approaching direction of the moving object from the cylindrical binary image, and estimates a motion trajectory of the moving object based on the approaching direction and the top view binary image.

2. The detector according to claim 1, wherein
the image processing device includes:
a cylindrical binary image generator that generates a cylindrical image from the image information acquired by the image input device and generates a cylindrical binary image based on the cylindrical image;
a top view binary image generator that generates an top view image from the image information acquired by the image input device and generates a top view binary image based on the top view image;
an approaching direction detector that detects the approaching direction from the cylindrical binary image; and
a motion trajectory estimator that estimates the motion trajectory from the approaching direction and top view binary image.

3. The detector according to claim 1, wherein
the image input device is a fish-eye camera.

4. The detector according to claim 2, wherein
the image input device is a fish-eye camera.

5. The detector according to claim 2, wherein
the cylindrical image is generated by developing, on a virtual flat surface, the image information obtained by capturing an object existing on a virtual cylindrical surface with the image input device.

6. The detector according to claim 2, wherein
the top view image is generated by applying view point conversion to the image information obtained by image captured by the image input device.

7. The detector according to claim 2, wherein
the generation of the cylindrical binary image and top view binary image includes applying generation of a difference image from a background based on background correlation using an edge image and extraction of only a moving object region using a two-stage Otsu's binarization method considering a noise component to the cylindrical image and top view image independently of each other.

8. The detector according to claim 2, wherein
the estimation of the approaching direction of the moving object includes projection of the cylindrical binary image in a y-direction to calculate center of gravity coordinates and calculation of the approaching direction of the moving object from the calculated center of gravity coordinates.

9. The detector according to claim 2, wherein
the estimation of the motion trajectory includes rotation of the top view binary image using the approaching direction and correction of the rotation of the top view binary image such that the moving object always faces a predetermined direction, labeling of the rotation-corrected top view binary image to calculate a foot candidate region, estimation of a distance from a foot region by a weighted mean of an area of the foot candidate region, and calculation of a foot position for each frame based on the approaching direction and distance from the foot region.

10. A system comprising:
an electronic equipment to be operated by a user; and
the moving object detector according to claim 1 being mounted on the electronic equipment.

11. The system according to claim 10, wherein
the input image acquisition device captures an image of the user.
